(19) United States
(12) Patent Application Publication
(10) Pub. No.: US 2015/0197068 A1
(43) Pub. Date: Jul. 16, 2015

(54) METHOD OF MAKING COMPOSITE MATERIALS

(71) Applicant: Wayne State University, Detroit, MI (US)

(72) Inventors: Golam M. Newaz, Ann Arbor, MI (US); Mohammad Hailat, Windsor (CA)

(21) Appl. No.: 14/413,863

(22) PCT Filed: Jul. 10, 2013
(86) PCT No.: PCT/US13/49916

§ 371 Date: Jan. 9, 2015

Related U.S. Application Data
(60) Provisional application No. 61/669,862, filed on Jul. 10, 2012.

(51) Int. Cl. B32B 3/28; B32B 37/18; B32B 15/08; B32B 37/12

(52) U.S. Cl. CPC B32B 3/28; B32B 37/12; B32B 37/18; B32B 15/08; B32B 2605/08; B32B 2250/02; B32B 2255/06; B32B 2255/26; B32B 2262/106; B32B 2266/0278

(57) ABSTRACT

A method of making a hybrid material is described. The hybrid material comprises a metal substrate layer, a carbon fiber composite layer, and an adhesive layer. The adhesive layer may be a foam adhesive. The adhesive layer minimizes thermal distortion of the metal substrate layer and the carbon fiber composite layer such that both layers experience less than 5% out-of-plane distortion.

### CROSS-REFERENCE TO RELATED APPLICATIONS

This application claims the benefit of U.S. Provisional Application No. 61/669,862, filed on Jul. 10, 2012, entitled “MIXED MATERIAL SYSTEM MADE FROM CARBON FIBER COMPOSITE (CFC) AND METHOD SUBSTRATES,” the entire contents of which are incorporated herein by reference.

### BACKGROUND

The invention relates to a composition of and a method of making a hybrid material. More particularly, the invention relates to a method of combining a metal layer and a carbon fiber layer with an adhesive in such a way that thermal distortion of the materials is minimized or avoided.

The use of carbon fiber composite materials (CFCs) in the assembly of vehicles has been contemplated due to the combination of strength and light weight provided by these materials. However, CFCs are presently more expensive than the metals that make up the majority of vehicle components at present. Hybrid materials containing both CFC and metal portions could give vehicle parts the strength necessary to maximize passenger safety and structural integrity while decreasing weight and keeping costs relatively low. However, because metals and CFCs generally expand in greatly differing fashion when exposed to heat, such as that of a curing program, often distortion of one or both layers occurs.

A composition and a method of making a hybrid material is provided. The hybrid material comprises a carbon fiber layer and a metal substrate bridged by an adhesive layer. The carbon fiber layer may be a carbon fiber prepreg. The metal substrate may comprise aluminum or steel. The adhesive layer may comprise at least one of an isocyanate-containing polymer which may be a polyurethane, and may be a foam. The hybrid material can be used in the assembly of a vehicle. The properties of the adhesive layer serve to minimize deformation of the carbon fiber and metal layers.

### SUMMARY OF THE INVENTION

In one embodiment, the invention of the present disclosure provides a method of making a hybrid material. In a first step, the method comprises providing a carbon fiber layer and a metal substrate layer. In a second step, the method comprises joining the carbon fiber layer to the metal substrate layer with an adhesive. This process causes an out-of-plane distortion of less than about 5% to the carbon fiber layer and the metal substrate layer.

In another embodiment, the invention is a hybrid material comprising a carbon fiber layer, a metal substrate layer, and an adhesive layer. The adhesive layer is posited between the carbon fiber layer and the metal substrate layer. The hybrid material is made by a process that causes an out-of-plane distortion of less than about 5% to the carbon fiber layer and the metal substrate layer.

In another embodiment, the invention provides a method of using a hybrid material comprising a fast-cure carbon fiber prepreg layer, a metal substrate layer, and an adhesive layer, the adhesive layer being posited between the fast-cure carbon fiber prepreg layer and the metal substrate layer, in the assembly of a vehicle.

Further objects, features, and advantages of this application will become readily apparent to persons skilled in the art after a review of the following description, with reference to the drawings and claims that are appended to and form a part of this application.

### BRIEF DESCRIPTION OF THE DRAWINGS

Aspects of this application will be described by way of examples with reference to the accompanying drawings. They serve to illustrate several aspects of the present application, and together with the description provide explanation of the principles of the invention. In the drawings:

FIG. 1 is a perspective view of a hybrid material illustrating the alignment of the layers of the hybrid material.

FIG. 2 is a cross-sectional view of a hybrid material illustrating the alignment of the layers of the hybrid material.

FIG. 3 is a flow chart illustrating steps in assembling the hybrid material in one embodiment of the invention.

### DETAILED DESCRIPTION

The terms “substantially” or “about” used herein with reference to a quantity includes variations in the recited quantity that are equivalent to the quantity recited, such as an amount that is equivalent to the quantity recited for an intended purpose or function, especially referring to quantities that would fall within expected tolerances that would be appreciated as functionally equivalent by a practitioner of the art.

The present invention relates to a composition of and a method of making a hybrid material. Bimaterials comprising metals and carbon fiber composites may be used for lightweighting in vehicles and machinery. The inventive hybrid material of the present disclosure represents a family of such biomaterials which comprise a metal substrate, a carbon fiber layer, and an adhesive bridging the metal and carbon fiber layers. The adhesive serves as a means of controlling thermal distortion that would otherwise occur in a hybrid material made from components with differing coefficients of thermal expansion.

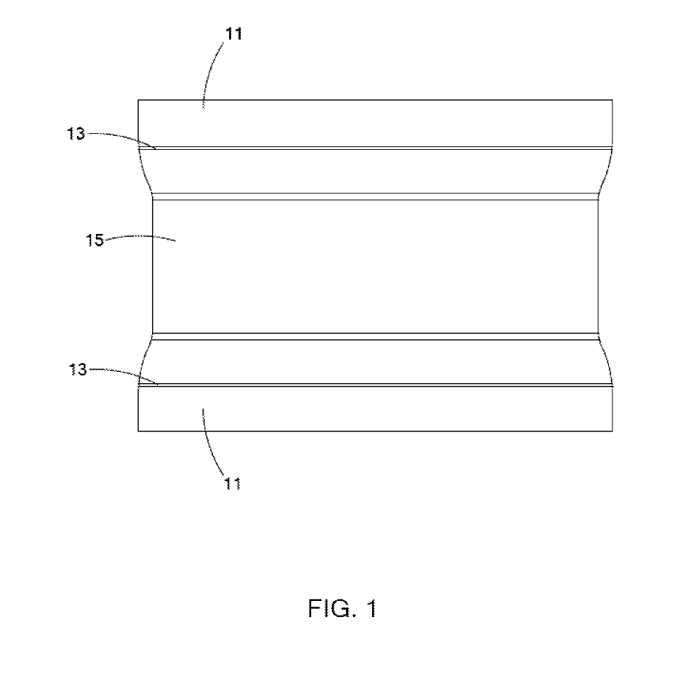

In FIG. 1, an exemplary hybrid material is illustrated. The outermost layer 11 comprises the metal substrate which forms the support for the hybrid material. Attached to metal substrate layer 11 is adhesive 13, the nature of which will be described in more detail below. Finally, the innermost layer 15 comprises the carbon fiber composite. The hybrid material as depicted represents a product of the hybrid material manufacturing process.

In certain embodiments, carbon fiber composite layer 15 can be preimpregnated with a resin such as an epoxy. Such a material is referred to as a carbon fiber pre-preg. Pre-pregs are well known in the art and are commercially available. A pre-preg can be a partially cured material which undergoes a relatively slow curing process at low temperatures, but which cures and stiffens significantly more quickly when heated in, for example, an autoclave or an oven. For longer-term storage, pre-pregs can be refrigerated, as the lower temperature slows the curing process further. Pre-pregs can be autoclavable materials and can also be out-of-autoclave materials. Temperature ranges that can be used in the curing step range from about 150° F. to about 500° F., or about 200° F. to about 400° F., or about 250° F. to about 350° F., or about 270° F. to about325° F., or about 300° F.

In one embodiment, the pre-preg can be a fast-curing carbon fiber pre-preg. The use of a fast-curing pre-preg can solve a problem known in the field at the moment where costs are exacerbated due to a relatively lengthy curing cycle (about 90 minutes or more) in a high energy-consuming autoclave. A fast-curing pre-preg may cure in about 3 to about 60 minutes, or in about 3 to about 30 minutes, or in about 3 to about 15 minutes, or in about 3 to about 10 minutes, or in about 5 to about 10 minutes, or it may cure in about 3 to about 5 minutes.

The CFC may take the form of a composite laminate. A variety of alignments among the fibers of the CFC are envisioned as being useful in this invention. In the present invention, a wide variety of carbon fiber structures are envisioned as being suitable for inclusion in the inventive hybrid materials. The fibers may be unidirectional, angle-ply, cross-ply, woven in a two-dimensional or in a three-dimensional weave, or any other configuration. One sheet of CFC may be used, or in some embodiments, multiple sheets of CFC may be used. The CFC may have anisotropic, orthotropic, or quasi-isotropic properties based on the properties of the sheets that comprise the layers of the CFC and their arrangement in three dimensions.

The metal substrate layer 11 can be a substantially uniform metal or metal alloy. In one embodiment of the present invention, the metal layer 11 constitutes greater than 50% of the mass of the hybrid material. In another embodiment, the metal layer is greater than 70% of the mass of the hybrid material. In one embodiment of the invention, the metal layer 11 comprises steel. In another embodiment, the metal layer 11 comprises aluminum. Other metals, such as magnesium, and their alloys are also suitable for inclusion in the hybrid materials of this invention.

The adhesive layer 13 can encompass a range of properties and activities. The adhesive layer has the ability to adhere to both the metal substrate layer 11 and the CFC layer 15, including those that comprise pre-pregs. In some embodiments, the adhesive may comprise a polymeric layer. In other embodiments, the adhesive may comprise a glass fiber fabric. The adhesive layer has the property of reducing thermal distortion to the metal substrate layer and the CFC layer during the assembly, curing, and any further treatment process.

The adhesive may be chosen from many different types and classes of adhesive. In one embodiment, the adhesive comprises a polymer adhesive. In another embodiment, the adhesive comprises a resin. An adhesive may be selected from the group comprising of a polyacrylic, cyanoacrylate, epoxies, isobutyl cyanoacrylate, polyvinyl acetate, bismaleimide adhesives, polyimides, polytetrafluoroethylene (Teflon), and other adhesives known in the art. Adhesives with foaming characteristics can be part of this embodiment. Adhesives with certain modification with nanoparticles are also part of this desired system. In a preferred embodiment, the adhesive is polymer comprising isocyanate groups.

The adhesive may take many different forms. In one embodiment, the adhesive comprises an adhesive tape. In another embodiment, the adhesive comprises a spray adhesive. Other embodiments include film adhesives, putties, and cements.

In some embodiments, the adhesive may have foaming properties. Foaming occurs when pockets of gas are trapped within a liquid or a solid. A foaming adhesive may be preferred as a means of increasing one or more physical dimensions (length, width, height) of a part to be manufactured. The foam may also confer a beneficial property to a part to be manufactured from the hybrid material, such as the ability to mitigate the negative consequences of an external force or excessive temperature, or to provide a desired amount of stiffness or rigidity to the part to be manufactured.

In some embodiments, it may be preferable that the adhesive comprise a single type and format of adhesive. In other embodiments, it may be preferable to combine more than one type and/or format of adhesive in order to make a hybrid material which includes all characteristics desired.

In one aspect, the adhesive may comprise a material that provides a means of compensating for the differing coefficients of thermal expansion of the metal layer and the CFC layer. The coefficient of thermal expansion describes how the size of an object changes with a change in temperature. In the case of metals, the coefficient is generally positive, describing expansion as the object increases in temperature. In the case of CFC, the coefficient is generally negative, meaning that the object made of CFC contracts or shrinks as temperature increases.

As a result, affixing a CFC to a metal and then applying heat can cause a deformation of the hybrid material as one layer expands and the other contracts. An adhesive layer that changes structure to substantially eliminate deformation provides a means of fabricating hybrid materials that will have predictable and usable shapes following the curing process. In particular, the adhesive functions to keep thermal distortion within 5% of out-of-plane deformation that may result from joining a metallic part to a CFC part with or without using conventional adhesives.

The adhesive, such as a foam adhesive, may have flow properties that behave in predictable ways during processing. For instance, the flow properties of the adhesive at room temperature and above, and while cooling from a high temperature to room temperature, can allow for expansion and contraction at the interface of a metal substrate layer and a CFC layer such that the metal and CFC act as though they are completely unconstrained. After cooling and setting, the adhesive can then become semi-rigid or rigid and can function as a structural part of the hybrid material.

The adhesive employed in the manufacture of a hybrid material comprises the ability to minimize or eliminate residual stress from curing and other manufacturing processes. Depending upon the applications in which the hybrid materials are eventually intended to be used, the identities of the metal and carbon fiber layers, and the difference in coefficients of thermal expansion in the metal and carbon fiber layers, different adhesives with different properties (for example, foaming) may be employed.

An advantageous embodiment of this invention is one in which a metal substrate layer is joined to a CFC layer by a foaming adhesive which can control both thermal distortion and build up an inner thickness h. The inner thickness h helps to increase bending stiffness, EI, where E is the flexural modulus and I is the second moment of inertia as calculated by the formula I=(1/12)bh³. In a case when a hybrid material is fashioned into for instance a beam, the b term in the above equation represents the width of the beam, and h the thickness. Because the inner thickness h is cubed in this equation, a small increase in inner thickness can result in a far stiffer end product.

In some instances it may be preferred to include nanomaterials within the adhesive. The nanomaterials can serve any purpose, such as functioning as the adhesive itself, or as a foaming agent.

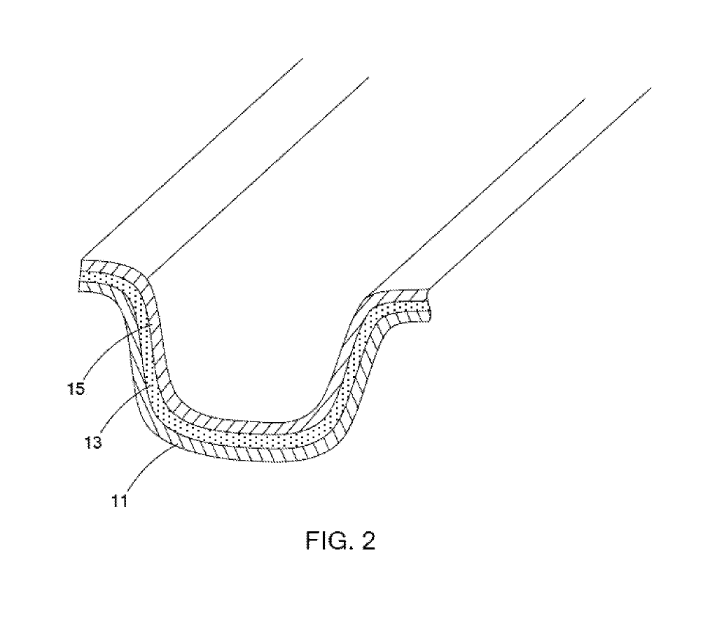

Hybrid materials can be manufactured in a variety of shapes. In some cases a substantially planar sheet of hybrid material can be employed in the final product. However, any shape that can be fabricated from metal or carbon fiber composite alone can be made from a hybrid material. As illustrated in FIG. 1 and FIG. 2, for example, a substantially U-shaped beam of composite material has been made using this technique.

Another parameter of hybrid materials that is tunable is their bending stiffness or flexural rigidity. Bending stiffness is represented by the formula EI, where E is the elastic modulus of the object and I represents its area moment of inertia. The hybrid material of the present disclosure can achieve the desired bending stiffness in a number of ways: in selecting the type of metal or metal alloy used in the metal substrate layer; in selecting the number of sheets of CFC and their orientation relative to one another (oriented in the same direction or rotated so as to vary the arrangement of the fibers on a sheet-by-sheet basis), the arrangement of the fibers of the CFC layer, and whether the fibers of the CFC are woven or not (and if woven, whether as a two-dimensional or a three-dimensional weave); and in selecting characteristics of the adhesive, including the nature of the adhesive (for instance, what type of chemical makes up the adhesive polymer), the format of the adhesive (whether spray, tape, or so forth), whether the adhesive is a foaming adhesive or not and if so the extent to which foaming is permitted. In some embodiments, it will be preferable for the hybrid material to have a bending stiffness EI which is substantially the same as or greater than the metal or carbon fiber layer alone.

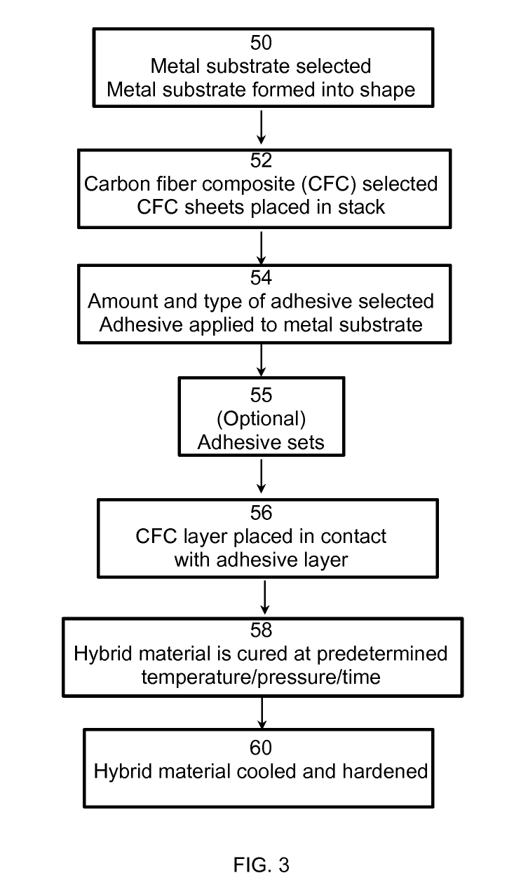

In FIG. 3, a process for creating a hybrid material in accordance with one embodiment of the present disclosure is illustrated. In first step 50, a metal substrate is selected and formed into the desired shape. Proceeding to second step 52, a determination of the number and character (fiber orientation, weave, etc.) of carbon fiber composite sheets is made and the CFC sheets are placed together in a stack. In third step 54, the amount and character of the adhesive is determined and the adhesive is applied to the metal substrate. If it is required, such as in the case of a liquid adhesive, optional step 55 allows for the setting or drying of the adhesive. In fourth step 56, the CFC is placed in physical contact with the adhesive layer. Continuing to fifth step 58, a curing temperature, pressure, and time are determined, and the pre-cured hybrid material is placed in the curing oven. Depending on the nature of the adhesive and or the CFC pre-preg, the ramp-up to the curing temperature may be slow (for instance, increasing at a rate of one degree per minute or the like) or may be rapid. Finally, in sixth step 60, the hybrid material is cooled and allowed to set and harden.

In an alternative process (not shown) the adhesive is instead applied to a surface of a CFC sheet and as a result the order of steps 54 and 56 is reversed.

Many applications for the hybrid materials of this disclosure are envisioned. In particular, these materials will be useful in lightweighting of vehicle components and will provide an economical alternative to pure CFC components by retaining some (more affordable) metal character but realizing a lighter weight due to the use of CFC, while retaining stiffness and structural integrity comparable to either of the metal or the CFC portions. The types of vehicles that these components may be used in include but are not limited to automobiles, trucks, buses, locomotives, rail cars, recreational vehicles, aircraft, spacecraft, seafaring vessels, and motorcycles. Portions of automobiles, for instance, that may be lightweighted using these hybrid materials include but are not limited to A pillars, arcuate B-pillars, rocker panels, side moldings, bumpers, crushcans, floor X-members, headers, roof bows, and the like.

The following non-limiting examples of construction of hybrid materials in accordance with the present disclosure are now provided. A person skilled in the art will appreciate that other embodiments of the invention are possible and that the examples that follow are merely illustrative.

### EXAMPLE 1

A metal substrate layer comprising a sheet of aluminum was sprayed with an adhesive layer comprising polyurethane foam which was allowed to set and strengthen for 24 hours. Two layers of carbon fiber were attached to the foam adhesive layer and the hybrid material underwent a curing cycle of 20 minutes at 270° F.

### EXAMPLE 2

A metal substrate layer comprising a sheet of aluminum was bent into a configuration that was substantially U-shaped. Five sheets of carbon fiber composite were stacked vertically in ABABA fashion, where those sheets indicated as B were rotated 90 degrees from the direction of the sheet in the A orientation. The adhesive layer comprised a sheet of Teflon (PTFE) that was placed between the metal and CFC. The composite material was cured at 270° F. for 20 minutes.

### EXAMPLE 3

A layer of firm acrylic foam with a thickness of 0.01 inch was placed between a carbon fiber composite layer and an aluminum layer. The curing cycle was tuned to be 270° F. and 1000 lb of pressure. The resulting composite material was found to be rigid following the curing cycle. Similar compositions with the thickness of the adhesive layer increased to 0.025 inch demonstrated similar rigidity to the hybrid material made with 0.01 inch adhesive but was able to bear a greater load.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

1. A method of making a hybrid material, the method comprising:
providing a carbon fiber layer and a metal substrate layer; and
adhering the carbon fiber layer and the metal substrate layer with an adhesive to define the hybrid material, each of the carbon fiber layer and the metal substrate layer having an out-of-plane distortion of less than about 5%.

2. The method of claim 1 further comprising a curing step comprising heating the hybrid material to a first temperature and cooling the hybrid material to a second temperature.

3. The method of claim 2 wherein the carbon fiber layer comprises a carbon fiber prepreg.

4. The method of claim 3 wherein the carbon fiber layer has a first coefficient of thermal expansion, the metal substrate layer has a second coefficient of thermal expansion, and the first coefficient of thermal expansion is different from the second coefficient of thermal expansion.

5. The method of claim 4 wherein the carbon fiber prepreg comprises an out-of-autoclave prepreg.

6. The method of claim 5 wherein the adhesive comprises an isocyanate-containing polymer.

7. The method of claim 5 wherein the adhesive comprises a polyurethane.

8. The method of claim 7 wherein the adhesive comprises a foam.

9. The method of claim 1 wherein the process causes the adhesive to undergo a controlled increase in thickness which increases rigidity of the hybrid material.

10. The method of claim 1 wherein the hybrid material is used in the assembly of a vehicle.

11. A hybrid material comprising a carbon fiber layer, a metal substrate layer, and an adhesive layer, the adhesive layer being posited between the carbon fiber layer and the metal substrate layer, the hybrid material being made by a process that causes an out-of-plane distortion of less than about 5% to the carbon fiber layer and the metal substrate layer.

12. The hybrid material of claim 11 wherein the metal substrate comprises aluminum or steel.

13. The hybrid material of claim 11 wherein the carbon fiber layer comprises a carbon fiber prepreg.

14. The hybrid material of claim 11 wherein the adhesive layer comprises an isocyanate-containing polymer.

15. The hybrid material of claim 14 wherein the isocyanate-containing polymer is a polyurethane.

16. The hybrid material of claim 15 wherein the isocyanate-containing polymer comprises a foam.

17. The hybrid material of claim 11 wherein the adhesive layer has undergone a controlled increase in thickness which results in an increase in rigidity of the hybrid material.

18. A method of using a hybrid material comprising a fast-cure carbon fiber prepreg layer, a metal substrate layer, and an adhesive layer, the adhesive layer being posited between the fast-cure carbon fiber prepreg layer and the metal substrate layer, in the assembly of a vehicle.

19. The method of claim 18 wherein the metal is aluminum or steel.

20. The method of claim 19 wherein the vehicle comprises an automobile, a truck, a bus, a locomotive, a rail car, a recreational vehicle, an aircraft, a spacecraft, a seafaring vessel, or a motorcycle.
